(19) United States
(12) Patent Application Publication
(10) Pub. No.: US 2025/0266739 A1
(43) Pub. Date: Aug. 21, 2025

(54) HYBRID GENERATOR

(71) Applicant: Imperial Industrial Supply Co., Ontario, CA (US)

(72) Inventor: Robert Johnson, Ontario, CA (US)

(73) Assignee: Imperial Industrial Supply Co., Ontario, CA (US)

(21) Appl. No.: 19/059,217

(22) Filed: Feb. 20, 2025

Related U.S. Application Data
(60) Provisional application No. 63/555,447, filed on Feb. 20, 2024.

(51) Int. Cl. H02K 7/18; F02B 63/04; H02K 11/00

(52) U.S. Cl. CPC H02K 7/1815; F02B 63/042; H02K 11/0094

(57) ABSTRACT

A hybrid generator for supplying AC power to an AC output is provided. The hybrid generator includes an engine-driven generator, and a lithium battery system that is electrically and mechanically coupled to the engine-driven generator. The engine-driven generator provides electrical power and has a first output capacity. The lithium battery system provides electrical power and has a second output capacity. The engine-driven generator and the lithium battery system are able to operate in parallel to supply power to the AC output of the hybrid generator at an output capacity that is greater than the first or second output capacity. Also provided is a method for operating a hybrid generator.

### CROSS-REFERENCE TO RELATED APPLICATIONS

This application is based upon and claims priority from prior U.S. Provisional Patent Application No. 63/555,447, filed Feb. 20, 2024, the entire disclosure of which is herein incorporated by reference.

### FIELD OF THE INVENTION

The present invention generally relates to generators, and more specifically to hybrid generators that combine a portable engine-driven generator and a lithium battery system.

### BACKGROUND OF THE INVENTION

Portable engine-driven generators are frequently used to provide backup power in emergency situations. An engine-driven generator that is occasionally refueled can provide backup power for a practically unlimited time but produces a high level of noise during operation. This is undesirable in many situations, such as during the night. Lithium battery systems have been introduced as an alternative to engine-driven generators. A lithium battery system can provide backup power with little to no noise but only for a limited time before the batteries become discharged.

Further, a large generator or a large lithium battery system is required to provide the backup power necessary to run a large air conditioner, well pump, or electric motor. Such devices present a large inductive load that makes a much larger surge of power necessary to start the device than is required during operation. For example, a large air conditioner with a five ton (or 60,000 BTU) cooling capacity typically requires 120 amps to start but then uses only 25 amps during operation. Thus, a large generator with a capacity of 120 amps or more would be required to provide the backup power that is necessary to operate such a large air conditioner.

In view of the foregoing, there exists a need for an improved generator.

### SUMMARY OF THE INVENTION

One embodiment of the present invention provides a hybrid generator for supplying AC power to an AC output. The hybrid generator includes an engine-driven generator, and a lithium battery system that is electrically and mechanically coupled to the engine-driven generator. The engine-driven generator provides electrical power and has a first output capacity. The lithium battery system provides electrical power and has a second output capacity. The engine-driven generator and the lithium battery system are able to operate in parallel to supply power to the AC output of the hybrid generator at an output capacity that is greater than the first or second output capacity.

Another embodiment of the present invention provides a hybrid generator for supplying AC power to an AC output. The hybrid generator includes an engine-driven generator, and a lithium battery system that is electrically and mechanically coupled to the engine-driven generator. The engine-driven generator provides electrical power and has a first output capacity. The lithium battery system provides electrical power and has a second output capacity. The engine-driven generator and the lithium battery system are able to operate separately so as to supply continuous uninterrupted power to the AC output of the hybrid generator when one of the engine-driven generator and the lithium battery system shuts off or otherwise becomes incapacitated.

Yet another embodiment of the present invention provides a method for operating a hybrid generator that supplies AC power to an AC output. According to the method, there is provided an engine-driven generator that is configured for providing electrical power and that has a first output capacity, and there is also provided a lithium battery system that is configured for providing electrical power and that has a second output capacity. In a first operating mode, the engine-driven generator and the lithium battery system are connected in parallel so as to supply power to the AC output of the hybrid generator at an output capacity that is greater than the first or second output capacity.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 is a front perspective view of a hybrid generator according to one embodiment of the present invention;

FIG. 2 is a back perspective view of the hybrid generator of FIG. 1;

FIG. 3A shows a back perspective view of the lithium battery system of the hybrid generator of FIG. 1;

FIG. 3B shows a front perspective view of the lithium battery system of FIG. 3A with its transport handle retracted;

FIG. 3C shows a front perspective view of the lithium battery system of FIG. 3A with its transport handle extended;

FIG. 4 shows a front perspective view of the lithium battery system of FIG. 3A with the outer casing removed;

FIG. 5 shows the lithium battery system of FIG. 3A mounted on a wall of a garage;

FIG. 6 is an exploded view of the lithium battery system shown in FIG. 4; and

FIG. 7 is a block diagram of the control module of FIG. 6.

### DETAILED DESCRIPTION

As required, embodiments of the present invention are disclosed herein; however, it is to be understood that the disclosed embodiments are merely examples and that the systems and methods described below can be embodied in various forms. Therefore, specific structural and functional details disclosed herein are not to be interpreted as limiting, but merely as a representative basis for teaching one of ordinary skill in the art to variously employ the present subject matter in virtually any appropriately detailed structure and function. Further, the terms and phrases used herein are not intended to be limiting, but rather, to provide an understandable description of the concepts.

Embodiments of the present invention provide a hybrid generator that combines a portable engine-driven generator and a lithium battery system. One embodiment provides a hybrid generator in which electrical power provided by an engine-driven generator is combinable with electrical power provided by a lithium battery system to operate a large inductive load. In some embodiments, the engine-driven generator and the lithium battery system can operate separately to provide continuous uninterrupted power when one is shut off or can no longer provide power. In one embodiment, the lithium battery system is removable from the engine-driven generator for use independent of the hybrid generator.

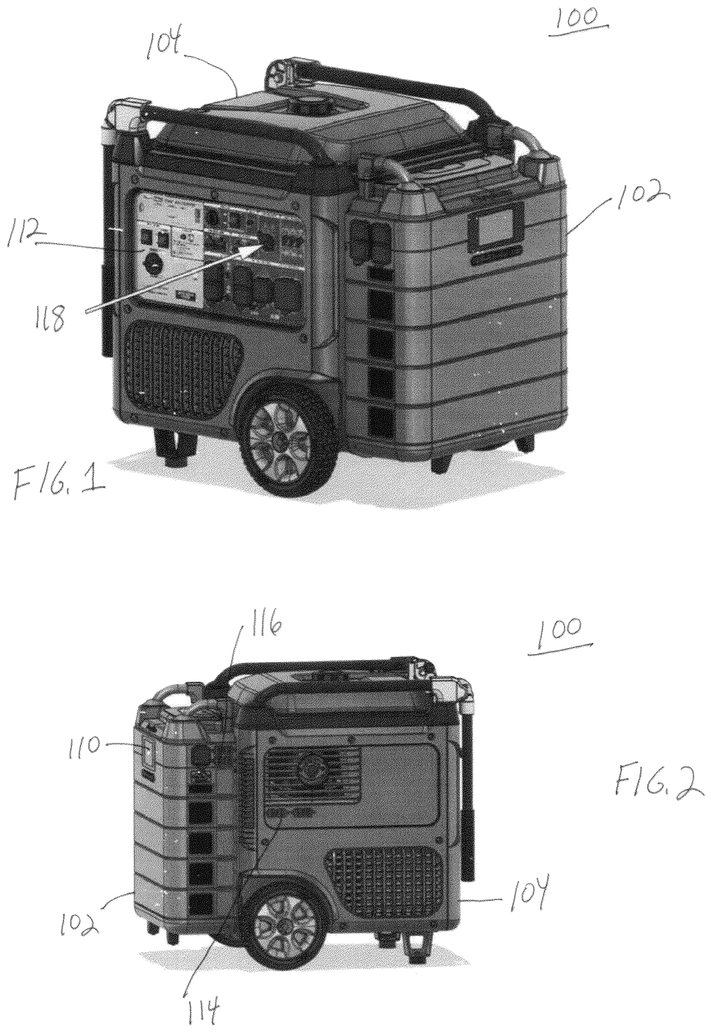

FIGS. 1 and 2 show a hybrid generator according to one exemplary embodiment of the present invention. The hybrid generator 100 includes an engine-driven generator 104, and a lithium battery system 102 that is electrically and mechanically coupled to the generator 104. The generator 104 is an inverter-type portable unit, which includes an inverter, capable of supplying a maximum of several thousand watts (e.g., 2,000 to 7,000 watts) of electrical power. In further embodiments, the generator 104 is a handcart-mounted portable unit, which may include or be coupled to an inverter, capable of supplying several thousand watts (e.g., 6,000 to 18,000 watts) of electrical power. The generator 104 of the illustrated embodiment runs on one or more of gasoline, diesel fuel, propane, and natural gas. In further embodiments the generator 104 runs on another fuel such as hydrogen.

The generator 104 includes a control module having a controller for a control system that monitors and controls the operation of the generator. For example, the controller and control system of the generator 104 manage various relays and circuits to control the routing of power between the generator 104, lithium battery system 102, and the inputs and outputs of the hybrid generator. The control module also includes an interface 112 that allows a user to control and monitor operational settings and power output. The back of the generator 104 has a set of two plugs 114 for electrically connecting to the lithium battery system 102.

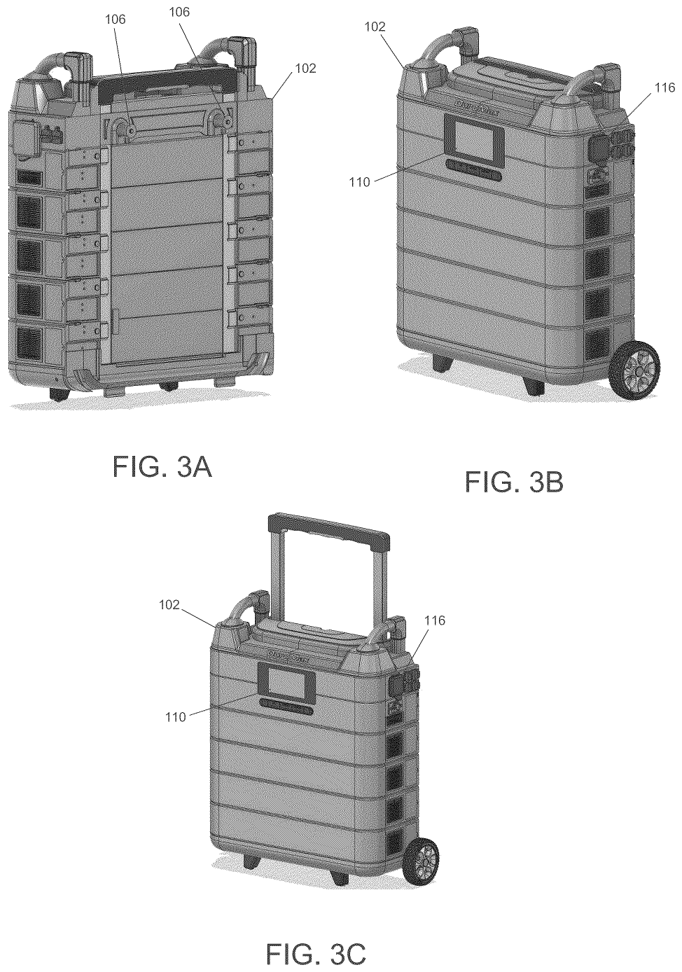

FIGS. 3A and 3B show the lithium battery system of the hybrid generator of FIG. 1. The lithium battery system 102 includes a single lithium home backup style battery pack with a capacity of several thousand watts (e.g., 3,000 to 8,000 watts). Such lithium home backup style battery packs are commercially available (e.g., from Honghaosheng (HHS) Energy of Shenzhen, China at http://www.hhs-energy.com). In further embodiments, multiple battery packs are mechanically coupled and electrically connected in parallel to make up a lithium battery system 104 with a greater capacity. For example, two to ten battery packs can be connected in parallel to provide up to 60,000 watts of electrical power.

The lithium battery system 102 is removably attached to the generator 104 by a mounting mechanism. In the illustrated embodiment, the lithium battery system 102 is mechanically coupled to the generator via posts 106, and can be removed by releasing one or more locking members that prevent accidental removal. The lithium battery system 102 comes off in one piece and can be used independently of the generator 104. For example, the lithium battery system 102 could be used alone as a wheeled power cart-style mobile power source as shown in FIG. 3C, or could be attached to a house-based system as shown in FIG. 5. The lithium battery system of the illustrated embodiment has a handle that can be extended to facilitate transport of the system. In further embodiments, the lithium battery system 102 is permanently attached to the generator 104 or is otherwise integrated to or within the generator 104.

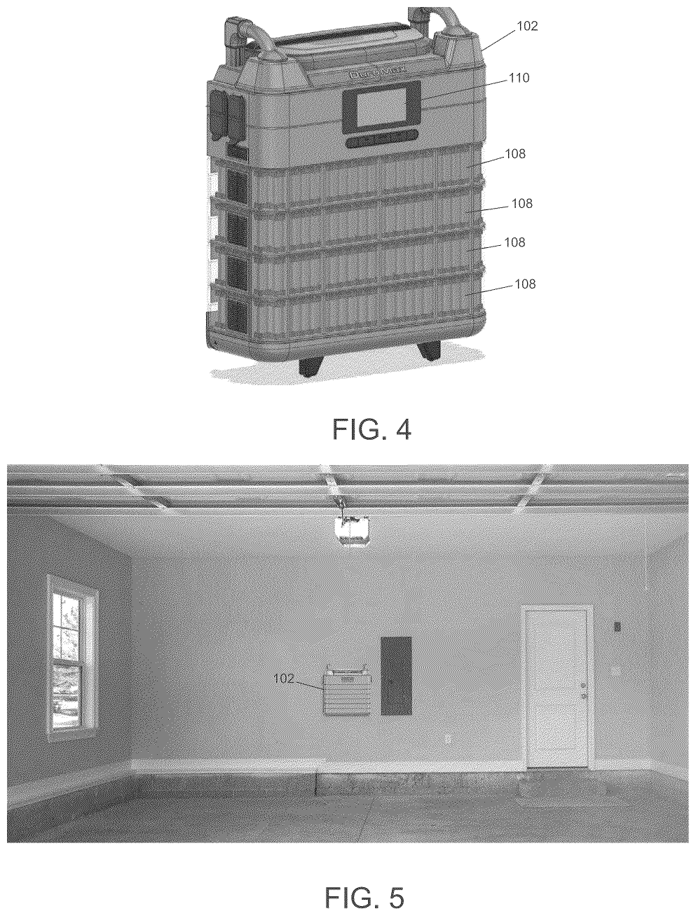

As shown in FIG. 4, the lithium battery system 102 of the illustrated embodiment includes multiple lithium battery modules 108 that operate in parallel. A group of individual lithium batteries are coupled together inside a case to form each of the battery modules 108. The lithium battery system 102 also includes a control module having a controller for a control system that monitors and controls the operation of the battery system. The control module further includes an interface 110 that allows a user to control and monitor charging and power output, and a power inverter for supplying AC power. The lithium battery system 102 of the illustrated embodiment has a set of two plugs 116 for electrically connecting to the plugs 114 of the generator 104.

The plugs 114 of the generator 104 are electrically connected to the plugs 116 of the lithium battery system 102 to provide a parallel electrical connection between the lithium battery system 102 and the generator 104, similar to the parallel connection that is possible between two inverter generators. This “paralleling” combines the two inverters (the inverter generator and the inverter battery system) to create a larger power output (i.e., increase the amperage without changing the voltage). In further embodiments, the generator 104 and the lithium battery system 102 are automatically electrically connected in parallel when the two are mechanically coupled together (e.g., via electrical connectors in the mounting mechanism). And in embodiments in which the lithium battery system 102 is permanently attached to the generator 104 or is otherwise integrated to or within the generator 104, the generator 104 and the lithium battery system 102 are permanently electrically connected in parallel.

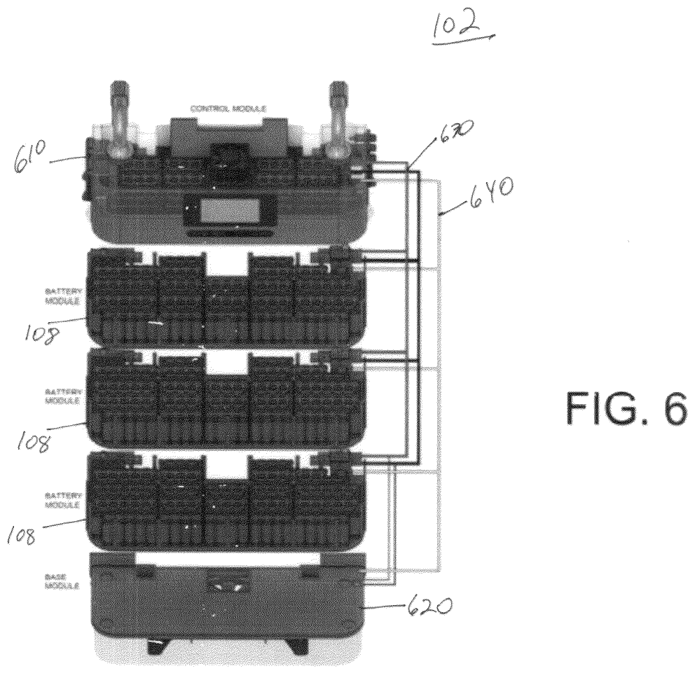

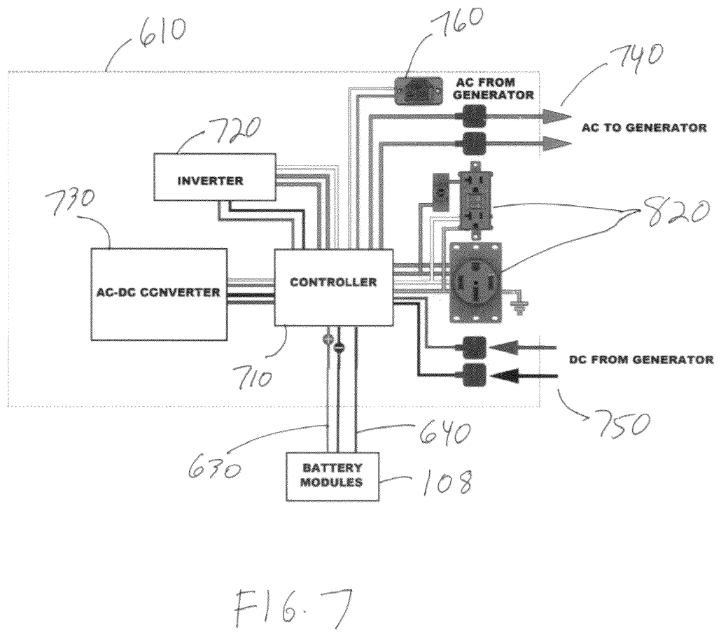

FIG. 6 is an exploded view that shows the modules of the lithium battery system shown in FIG. 4. The lithium battery system 102 of the illustrated embodiment has three lithium battery modules 108, a control module 610, and a base module 620. All of these modules are electrically interconnected by a pair of power lines 630 and a control data line 640. Each battery module 108 has individual lithium batteries that are interconnected so as to function as a single 48V battery. In turn, the three battery modules 108 are connected in parallel by the power lines 630 so that all of the battery modules of the lithium battery system 102 function together as a single 48V battery. This allows the number of battery modules 108 within the lithium battery system 102 to vary without changing the voltage. Adding or subtracting battery modules increases or decreases the maximum number of watts (i.e., amps) that can be supplied and the storage capacity (i.e., total amp-hours), but does not change the nominal output voltage from 48V. In one embodiment, a battery module 108 is held in the system by easy-to-use mounting and latching mechanisms that allow the battery module to be added or subtracted without tools.

The control module 610 and the base module 620 include cooling fans for expelling heat that is generated during operation (e.g., when supplying power or charging the batteries). Heat sinks and airways can also be provided in one or more of the modules. The positive and negative power lines 630 interconnect all of the battery modules 108 to form a 48V DC main supply line that is connected to the base module 620 and the control module 610. The main supply line powers internal components such as the controller and the fans, and couples power between the battery modules and the inputs and outputs of the lithium battery system 102. The control data line 640 is implemented by Cat 6 network cabling that transfers control data between the modules of the lithium battery system 102. In further embodiments, the control data line 640 utilizes a different type of communication, such as through USB interfaces and cabling.

FIG. 7 is a block diagram showing the components of the control module of FIG. 6. The control module 610 includes the controller 710, an inverter 720, an AC-DC converter 730, and interfaces for transferring power to and from the inputs and outputs of the lithium battery system 102. The controller 710 manages the control system that monitors and controls the operation of the lithium battery system 102. For example, the controller 710 and control system monitor the status of the batteries and can display current operating parameters, such as the charge level of the batteries, the battery discharge rate, and the charging rate. The inverter 720 is a 120V/240V split phase inverter that receives the 48V DC power from the battery modules 108, and performs DC to AC conversion so as to output AC power (e.g., 120V, 220V, and/or 240V AC power) that is sent to the AC output 740 and the AC output receptacles 820. The AC-DC converter 730 receives AC power (e.g., 120V AC power from an AC input receptacle 760), and outputs DC power (e.g., 60V or 48V) that is coupled to the battery modules 108 to charge the batteries. This 120V AC input receptacle 760 is a standardized receptacle that can be connected to the generator 104 or any other power source (e.g., line power for recharging the batteries using utility power when available).

The AC output 740 provides 240V AC power through a set of two plugs that are connected to the generator 104 for parallel operation. Alternatively, the AC output 740 can be connected with the AC output of another battery pack of the lithium battery system 102 for parallel operation. The DC input 750 is a set of two plugs that can be connected to the generator 104 or any other power source (e.g., solar panels) for receiving 48V DC power that is sent to the battery modules 108 to charge the batteries. The AC output receptacles 820 are standardized receptacles that provide 120V and 240V AC power. Any number of 120V and 240V receptacles can be provided, and some or all of these receptables can be protected by fuses or circuit breakers.

Thus, the inverter 720 of the lithium battery system 102 converts the 48V DC output of the lithium batteries into AC power (e.g., 240V AC power) that can be used in parallel with the output of the inverter of the generator 104 to produce a higher power (i.e., higher amperage) combined output. Alternatively, the AC power output by the inverter 720 of the lithium battery system 102 can be used directly from the lithium battery system 102.

The hybrid generator of the present invention makes it possible to operate in separate or parallel operating mode, and either the generator or the lithium battery system can be the primary power source in either mode. In “separate/generator primary” mode, the generator 104 is used to generate the power that is output from the hybrid generator. The lithium battery system 102 is used to generate the output power of the hybrid generator only after the generator 104 runs out of fuel or is otherwise incapacitated. This mode allows the hybrid generator to continue providing uninterrupted power until the generator 104 is refueled or repaired. After coming back online, the generator 104 also recharges the lithium battery system 102.

In “separate/battery primary” mode, the lithium battery system 102 is used to generate the power that is output from the hybrid generator. When the batteries are discharged down to a set minimum level, the generator 104 turns on and supplies power to recharge the batteries back up to a set maximum level. The generator 104 is also used to generate the output power of the hybrid generator only if the batteries become totally discharged (i.e., no longer be able to maintain the output voltage). In such a case, the lithium battery system 102 ceases supplying the output power until the generator 104 recharges the batteries back up to a set operational level. This mode allows the hybrid generator to provide power with as little noise as possible.

In “parallel/generator primary” mode, the generator 104 is used to generate the power that is output from the hybrid generator. However, if the power demands of the load exceed a set trigger level, the lithium battery system 102 operates in parallel with the generator 104 to provide the total output power required by the load. When the power demanded by the load falls below a set trigger level, the generator 104 goes back to generating all of the power that is output from the hybrid generator, and supplies power for recharging the lithium battery system 102. There can be different trigger levels for impulse power demand and constant power demand, and the trigger levels for starting and ending parallel operation can be the same or different. If the generator 104 runs out of fuel or otherwise becomes incapacitated, the lithium battery system 102 generates the output power of the hybrid generator. This mode allows the hybrid generator to provide more starting power or constant power than is possible by the generator 104 alone. By adjusting the trigger level settings to lower the maximum load of the generator 104, this mode can also be used to extend the run time of the generator 104 on a set amount of fuel.

In “parallel/battery primary” mode, the lithium battery system 102 is used to generate the power that is output from the hybrid generator. However, if the power demands of the load exceed a set trigger level, the generator 104 operates in parallel with the lithium battery system 102 to provide the total output power required by the load. When the power demanded by the load falls below a set trigger level, the lithium battery system 102 goes back to generating all of the power that is output from the hybrid generator. If the batteries are discharged down to a set minimum level, the generator 104 turns on and supplies power to recharge the batteries back up to a set maximum level. The generator 104 is also used to generate the output power of the hybrid generator if the batteries become totally discharged. As above, there can be different trigger levels for impulse power demand and constant power demand, and for starting and ending parallel operation. This mode allows the hybrid generator to provide more starting power or constant power than is possible by the lithium battery system 102 alone, and to provide maximum power with as little noise as possible.

Additionally, the hybrid generator could also be set to operate in “battery only” mode (e.g., when minimum noise is required) or in “generator only” mode (e.g., when the lithium battery system is removed or being changed). Further embodiments of the present invention provide any subset of these operating modes, and can provide other operating modes.

In the illustrated embodiment, a mode selector switch in the form of a control knob 118 is provided on the front of the generator 104 to allow a user to manually switch between the different operating modes. The control knob 118 interfaces the lithium battery system 102 with the generator 104 so as to integrate the operation of the lithium battery system 102 and the generator 104. In response to the setting of the control knob 118, the controller and control system of the generator 104, in conjunction with the controller and control system of the lithium battery system 102, acts to operate the generator 104 and the lithium battery system 102 as a single unit (i.e., hybrid generator).

In further embodiments, one or more buttons, knobs, toggles, or dials is provided on one or both of the interfaces 110 and 112 of the hybrid generator for manually switching between the different operating modes. Additionally or alternatively, mode switching and other settings can be controlled through a remote control, computer, or other device (e.g., a tablet or phone running an app). The mode and setting selection through such devices can be programmable (e.g., automated based on time of day, run time, power outage, power remaining, and the like). In some embodiments, only one operating mode is provided. And an automatic standby switch can be provided to automatically turn on the generator when there is a loss of power.

Accordingly, embodiments of the present invention can allow the generator 104 and the lithium battery system 102 to work together simultaneously to provide greater power. For example, if the generator 104 has a capacity of 10,000 watts and the lithium battery system 102 has a capacity of 7,000 watts, the hybrid generator has a capacity of 17,000 watts. This is beneficial for starting a large inductive load (such as a large air conditioner, well pump, or electric motor) that requires a large surge of power to start but then uses a significantly lower amount of power to run. For example, a five ton air conditioner typically requires 120 amps to start but then uses only 25 amps during operation. The additional power provided by the combination of the lithium battery system with the engine-driven generator can provide the needed surge of power to start the air conditioner, and then the engine-driven generator (or lithium battery system alone) can maintain the load during operation.

On its own, neither the engine-driven generator nor the lithium battery system would be able to start such a load. Thus, the hybrid generator can start larger loads than the engine-driven generator alone. Further, this allows a much smaller engine-driven generator to power such a load. A smaller engine-driven generator uses less fuel to maintain a load during operation. Thus, as compared with a conventional engine-driven generator for powering the same load, the hybrid generator uses less fuel and can run longer on a set amount of fuel.

Furthermore, embodiments of the present invention can allow the generator 104 and the lithium battery system 102 to work separately to provide continuous uninterrupted power when the generator 104 or the lithium battery system 102 is shut off or otherwise not available. This advantageously allows the hybrid generator to use the generator 104 to generate the output power during the day, while using the lithium battery system 102 to provide the output power at night. Thus, noise can be minimized at night (or any sensitive time), with the engine-driven generator providing the output power and recharging the batteries at other times.

As explained above, both the generator 104 and the lithium battery system 102 have a control module that includes a controller for a control system. Each of the control modules also includes relays and circuits that are controlled by the controller and control system (e.g., for routing power). In one exemplary embodiment, each of the controllers includes at least one processor or control circuit (e.g., a CPU) that is connected to a communication infrastructure (e.g., a communications bus, cross-over bar, or network). Various embodiments are described in terms of this exemplary control system. After reading this description, it will become apparent to one of ordinary skill in the art how to implement the present invention using other control systems and/or control architectures.

Each of the control modules can include a display processing unit that forwards graphics, text, and/or other data from the communication infrastructure (or from a frame buffer) for display on a display unit of the corresponding interface. For example, the display unit can include an LED read out that shows current operating parameters, selected settings, and the current operating mode. A keyboard/keypad (which can be physical and/or electronic) can also be included in the corresponding interface to receive user input and selections. Each of the control modules also includes a main memory, preferably random access memory (RAM), and a non-volatile memory. The non-volatile memory can include one or more of a solid-state drive (SSD), Flash memory, read only memory (e.g., EEPROM or PROM), and non-volatile random-access memory (NVRAM).

Each of the control modules can also include a communications interface that allows data to be transferred to and from external devices. Exemplary communications interfaces include network interfaces and communications ports. The data transferred via the communications interface is in the form of signals that can be, for example, electronic, electromagnetic, optical, or any other signal capable of being received by the communications interface. These signals are provided to the communications interface via a communications path (i.e., channel) that can be implemented using wire or cable, fiber optics, a cellular phone link, an RF link, or any other communications channels. The communications path can support transmission over one or more wireless communications modes, such as cellular telephone protocols (e.g., GSM, UMTS, LTE, or 5G) and/or wireless data communications protocols (e.g., Wi-Fi or Bluetooth®).

It can be advantageous to set forth definitions of certain words and phrases used throughout this disclosure. The terms “a” or “an”, as used herein, are employed to describe elements and components described herein. This is done merely for convenience and to give a general sense of the scope of the disclosure. This description should be read to include one or at least one and the singular also includes the plural unless it is obvious that it is meant otherwise. The term plurality, as used herein, is defined as two or more than two. The term another, as used herein, is defined as at least a second or more. The term “coupled,” as used herein, is defined as “connected,” although not necessarily directly, and not necessarily mechanically.

The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A; B; C; A and B; A and C; B and C; and A, B, and C.

As used herein, the term “about” or “approximately” applies to all numeric values, whether or not explicitly indicated. These terms generally refer to a range of numbers that one of ordinary skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one of ordinary skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one of ordinary skill in the art would know to be a reasonable tolerance for the parts mentioned.

It will be appreciated by one of ordinary skill in the art that the present invention is not limited to what has been particularly shown and described herein above. In addition, unless mention was made above to the contrary, it should be noted that all of the accompanying drawings are not to scale. There are many different features to the present invention and it is contemplated that these features may be used together or separately. Thus, the present invention should not be limited to any particular combination of features or to a particular application. Further, it should be understood that variations and modifications within the spirit and scope of the present invention might occur to those of ordinary skill in the art to which the present invention pertains. Additionally, an embodiment of the present invention may not include all of the features described above. Accordingly, all expedient modifications readily attainable by one versed in the art from the disclosure set forth herein that are within the scope and spirit of the present invention are to be included as further embodiments of the present invention.

What is claimed is:

1. A hybrid generator for supplying AC power to an AC output, the hybrid generator comprising:
an engine-driven generator configured for providing electrical power, the engine-driven generator having a first output capacity; and
a lithium battery system that is electrically and mechanically coupled to the engine-driven generator, the lithium battery system being configured for providing electrical power and having a second output capacity,
wherein the engine-driven generator and the lithium battery system are configured to operate in parallel to supply power to the AC output of the hybrid generator at an output capacity that is greater than the first or second output capacity.

2. The hybrid generator of claim 1,
wherein the first output capacity of the engine-driven generator is insufficient to start a predetermined inductive load,
the second output capacity of the lithium battery system is insufficient to start the predetermined inductive load, and
the engine-driven generator and the lithium battery system are configured to operate in parallel to supply sufficient power to the AC output of the hybrid generator to start the predetermined inductive load.

3. The hybrid generator of claim 1, wherein the engine-driven generator is an inverter-type portable unit.

4. The hybrid generator of claim 1, wherein the engine-driven generator is a handcart-mounted portable unit.

5. The hybrid generator of claim 1, wherein the lithium battery system includes at least one lithium battery pack.

6. The hybrid generator of claim 1, wherein the lithium battery system includes a plurality of separate lithium battery packs that are mechanically coupled and electrically connected in parallel.

7. The hybrid generator of claim 1, wherein the lithium battery system is removably attached to the engine-driven generator.

8. The hybrid generator of claim 7, wherein the lithium battery system is configured such that, when removed from the engine-driven generator, the lithium battery system can be used to provide electrical power independent of the generator.

9. The hybrid generator of claim 1, wherein the lithium battery system includes at least one lithium battery pack that comprises:
a control module that includes a controller that monitors and controls operation of the lithium battery pack; and
a plurality of lithium battery modules that are electrically connected in parallel for providing electrical power.

10. The hybrid generator of claim 9, wherein the control module of the lithium battery pack comprises:
an inverter that receives DC power from the lithium battery modules and outputs AC power; and
an AC-DC converter that receives AC power from the engine-driven generator and outputs DC power that is supplied to the lithium battery modules.

11. The hybrid generator of claim 9, wherein the lithium battery system is configured such that an additional lithium battery module can be added to the lithium battery pack to increase the second output capacity of the lithium battery system without changing the nominal output voltage of the lithium battery system.

12. The hybrid generator of claim 1, wherein the engine-driven generator and the lithium battery system are configured to operate in parallel to supply power to the AC output of the hybrid generator at an output capacity that is substantially equal to the first output capacity plus the second output capacity.

13. The hybrid generator of claim 1, wherein an AC output of the lithium battery system is electrically connected to the engine-driven generator so as to allow the engine-driven generator and the lithium battery system to operate in parallel.

14. A hybrid generator for supplying AC power to an AC output, the hybrid generator comprising:
an engine-driven generator configured for providing electrical power, the engine-driven generator having a first output capacity; and
a lithium battery system that is electrically and mechanically coupled to the engine-driven generator, the lithium battery system being configured for providing electrical power and having a second output capacity,
wherein, in a first mode, the engine-driven generator and the lithium battery system are configured to operate separately so as to supply continuous uninterrupted power to the AC output of the hybrid generator when one of the engine-driven generator and the lithium battery system shuts off or otherwise becomes incapacitated.

15. The hybrid generator of claim 14, wherein, in a second mode, the engine-driven generator and the lithium battery system are configured to also be able to operate in parallel to supply power to the AC output of the hybrid generator at an output capacity that is greater than the first or second output capacity.

16. The hybrid generator of claim 15, further comprising a switch for manually switching between operating in the first mode and operating in the second mode.

17. A method for operating a hybrid generator that supplies AC power to an AC output, the method comprising:
providing an engine-driven generator configured for providing electrical power and having a first output capacity;
providing a lithium battery system configured for providing electrical power and having a second output capacity; and
in a first operating mode, connecting the engine-driven generator and the lithium battery system in parallel so as to supply power to the AC output of the hybrid generator at an output capacity that is greater than the first or second output capacity.

18. The method of claim 17, further comprising:
in a second operating mode, operating the engine-driven generator and the lithium battery system separately so as to supply continuous uninterrupted power to the AC output of the hybrid generator when one of the engine-driven generator and the lithium battery system shuts off or otherwise becomes incapacitated.
